(19) United States
(12) Patent Application Publication
(10) Pub. No.: US 2018/0027634 A1
(43) Pub. Date: Jan. 25, 2018

(54) VEHICLE LIGHTING SYSTEM, AND METHODS OF USE AND MANUFACTURE THEREOF

(71) Applicant: Honda Motor Co., Ltd., Tokyo (JP)

(72) Inventor: Visishta DALAVAYI, Dublin, OH (US)

(21) Appl. No.: 15/217,415

(22) Filed: Jul. 22, 2016

(51) Int. Cl. H05B 37/02; H05B 33/08; F21V 19/02; B60Q 1/14; B60Q 1/30; B60Q 1/20; B60Q 1/26; B60Q 3/02; B60Q 1/24; B60Q 1/00

(52) U.S. Cl. CPC H05B 37/0272; H05B 37/0218; H05B 37/0227; B60Q 1/24; H05B 33/0854; F21V 19/02; B60Q 1/0023; B60Q 1/30; B60Q 1/20; B60Q 1/2665; B60Q 1/2669; B60Q 3/0279; B60Q 1/14; B60Q 2300/312; B60Q 2300/314; B60Q 2300/20; B60Q 2400/40

(57) ABSTRACT

A vehicle lighting system for use with a fob, the fob being configured to transmit a signal including a position of the fob relative to the vehicle, the vehicle including at least one area of passenger ingress/egress. The vehicle lighting system can include a plurality of light sources disposed at different locations on the vehicle. The vehicle lighting system can also include a processor. The processor can be configured to: receive the signal from the fob; determine a path of travel of the fob to the at least one area of passenger ingress/egress; select certain of the plurality of light sources that are capable of illuminating the path of travel; and activate the selected plurality of light sources to illuminate the path of travel.

### BACKGROUND

The disclosed subject matter relates to a vehicle lighting system, and methods of use and manufacture thereof. More particularly, the disclosed subject matter relates to methods and apparatus that enhance visibility during approach to and/or departure from a vehicle.

Many types of vehicles include lighting systems, which allow the vehicle to illuminate surfaces on which the vehicle travels and/or objects around the vehicle, as well as illuminate the vehicle itself for location and identification purposes. However, despite these lighting systems, vehicle operators and/or passengers may be impeded from entering or exiting the vehicle during instances of low ambient lighting, such as at night, or under certain conditions, such as rain, snow, etc. In other words, low light and/or certain conditions outside the vehicle, resulting in relatively poor visibility, may make it difficult for a vehicle occupant and/or operator to enter and/or exit the vehicle, thereby increasing risk of harm to the operator/passenger.

### SUMMARY

This poor visibility can be influenced by a variety of factors, including implementation of lighting systems configured to selectively switch on and direct a combination of light sources toward the operator/passenger to illuminate a pathway to/from the vehicle. However, various vehicular design factors may make it challenging to enhance visibility approaching and/or departing a vehicle under low light or other conditions. For example, primary lights on the vehicle serve to illuminate surfaces and objects during operation of the vehicle, and are thus oriented to project forward and rearward. These lights may therefore not illuminate (or sufficiently illuminate) sides of the vehicle at which doors for ingress/egress are located. Auxiliary lights may be positioned along sides of the vehicle, however these lights can lack the distance and brightness of projection of the primary lights described above. As a result, an area surrounding the vehicle can be subject to poor visibility during presence of low light or certain conditions. Alternatively, some primary or auxiliary lights may project too intensely under such circumstances, visually impairing an operator/passenger attempting to approach/retreat from the vehicle.

It may therefore be beneficial to provide a vehicle lighting system, and methods of use and manufacture thereof, that address at least one of the above and/or other challenges. In particular, it may be beneficial to enhance vehicle exterior illumination, such as by selectively projecting a combination of vehicle lights toward an approaching or retreating key fob carried by an operator/passenger to illuminate a pathway to/from the vehicle. For example, lights on a side of the vehicle, which the operator/passenger is approaching/retreating from, may switch on and track the path of the operator/passenger to illuminate the path of travel. The lights can further be motorized to alter direction of light projection and track a changing path, as well as to have varying intensity depending on distance of the operator/passenger from the vehicle.

Some embodiments are therefore directed to a vehicle lighting system for use with a fob, the fob being configured to transmit a signal including a position of the fob relative to the vehicle, the vehicle including at least one area of passenger ingress/egress. The vehicle lighting system can include a plurality of light sources disposed at different locations on the vehicle. The vehicle lighting system can also include a processor. The processor can be configured to: receive the signal from the fob; determine a path of travel of the fob to the at least one area of passenger ingress/egress; select certain of the plurality of light sources that are capable of illuminating the path of travel; and activate the selected plurality of light sources to illuminate the path of travel.

Some other embodiments are directed to a vehicle for use with a fob, the fob being configured to transmit a signal including a position of the fob relative to the vehicle. The vehicle can include at least one area of passenger ingress/egress; and a lighting system disposed at different locations on the vehicle. The lighting system can include a plurality of light sources disposed at different locations on the vehicle. The lighting system can also include a processor configured to: receive the signal from the fob; determine a path of travel of the fob to the at least one area of passenger ingress/egress; select certain of the plurality of light sources that are capable of illuminating the path of travel; and activate the selected plurality of light sources to illuminate the path of travel.

Still other embodiments are directed to a method of illuminating a vehicle lighting system of a vehicle for use with a fob, the fob being configured to transmit a signal including a position of the fob relative to the vehicle, the vehicle including at least one area of passenger ingress/egress, the vehicle lighting system including a plurality of light sources disposed at different locations on the vehicle, and a processor. The method can include: receiving the signal from the fob to the processor; determining a path of travel of the fob to the at least one area of passenger ingress/egress via the processor; selecting certain of the plurality of light sources that are capable of illuminating the path of travel via the processor; and activating the selected plurality of light sources to illuminate the path of travel via the processor.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a top view of a vehicle having an exemplary lighting system in accordance with the disclosed subject matter.

FIG. 2 is a schematic of the lighting system in accordance with the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

Various headings are provided below for convenience and clarity. However, these headings are not intended to limit the scope or content of the disclosure, and/or the scope of protection afforded the various inventive concepts disclosed herein.

### I. Vehicle and Lighting System

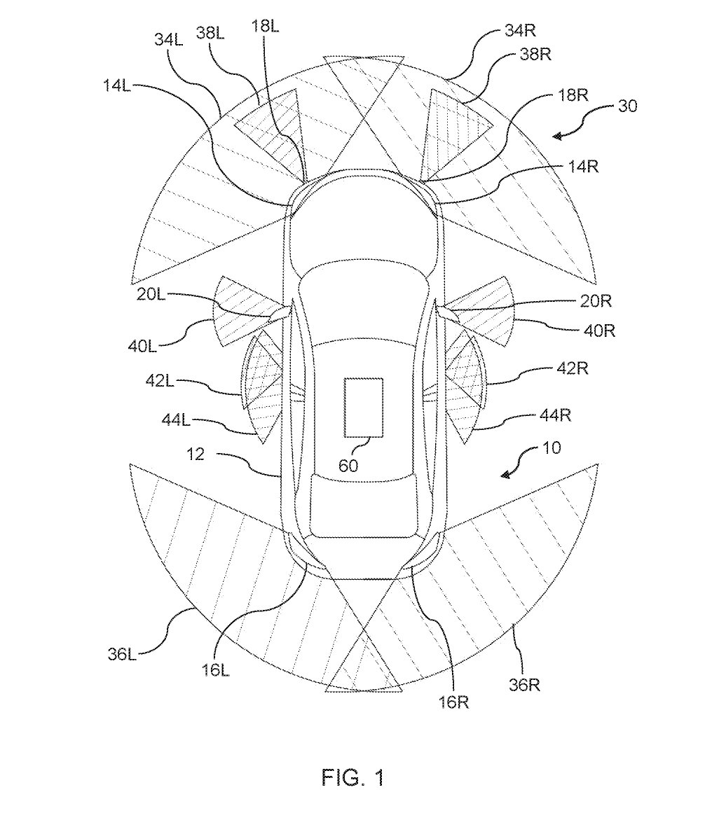

FIG. 1 is a top view of a vehicle 10 having an exemplary lighting system 30 in accordance with the disclosed subject matter. The vehicle 10 shown in FIG. 1 is primarily for use on paved roadways, and can be referred to as a passenger vehicle. The vehicle 10 may alternatively be a commercial vehicle, and can also be configured for use on unpaved roadways consisting of gravel, dirt, sand, etc.

However, the disclosed lighting system 30 can be used with any vehicle that is configured for travel along any one or combination of improved, unimproved, and unmarked roadways and paths consisting of gravel, dirt, sand, etc. For example, embodiments are intended to include or otherwise cover any type of automobile, including passenger car, minivan, truck, etc. In fact, embodiments are intended to include or otherwise cover configurations of the lighting system 30 for use with any other type of vehicle, such as an aircraft, boat, ship, train, spacecraft, etc. Some other embodiments can be used in non-vehicular applications, such as for any other situation where projecting certain lights in a system to illuminate a path may be desirable.

The vehicle 10 can include a body 12, a pair of headlights 14L,R, a pair of taillights 16L,R, a pair of fog lights 18L,R, a pair of mirror lights 20L,R, a pair of door handle lights 22L,R, a pair of underbody lights 24L,R, an interior lighting system 26, an ECU 60, a frame assembly, and a powertrain. The interior lighting system 26, the ECU, the frame assembly and the powertrain are omitted from FIG. 1 for simplicity and clarity of the drawings.

The pair of headlights 14L,R shown in FIG. 1 can be included in a front portion of the body 12 and may specifically be disposed within or above a front bumper. The headlights 14L,R can be oriented to face approximately forward while also being at least partially angled towards respective sides of the vehicle 10. The headlights 14L,R can include high beams, low beams, and any other intermediate or otherwise desirable projection angle, as well as turn signals. The headlights 14L,R may include halogen, high intensity discharge (HID), light-emitting diode (LED), or laser light sources. Each of the pair of headlights 14L,R may include any number of appropriate light sources, such as one, two, three, four, etc. Arrangements and orientations of light sources within the headlights 14L,R can vary depending on application to accommodate various function and design goals. Furthermore, the headlights 14L,R may comprise multiple headlight units such that the vehicle 10 has one, two, three, four, etc. headlights disposed on each side of the front portion.

The pair of headlights 14L,R can be configured to illuminate areas forward and to the sides of the vehicle 10 with headlight projections 34L,R extending therefrom. The headlight projections 34L,R can be configured to cover ground areas to illuminate surfaces near the vehicle 10, as well as projecting generally outward to illuminate other objects. The headlights 14L,R may further be configured as adaptive headlights capable of swiveling and moving light sources within respective headlight housings to alter illumination direction and targets of the headlight projections 34L,R. Intensity of the headlight projections 34L,R can also be adjusted so as to provide adequate illumination to observe ground surfaces and/or other objects without visually impairing other vehicle operators or pedestrians.

The pair of taillights 16L,R shown in FIG. 1 can be included in a rear portion of the body 12 and may specifically be disposed within or above a rear bumper. The taillights 16L,R can be oriented to face approximately rearward while also being at least partially angled towards respective sides of the vehicle 10. The taillights 16L,R can also include brake lights, reverse lights, and turn signals. The taillights 16L,R may include halogen, high intensity discharge (HID), light-emitting diode (LED), or laser light sources. Each of the pair of taillights 16L,R may include any number of appropriate light sources, such as one, two, three, four, etc. Arrangements and orientations of light sources within the taillights 16L,R can vary depending on application to accommodate various function and design goals. Furthermore, the taillights 16L,R may comprise multiple taillight units such that the vehicle 10 has one, two, three, four, etc. taillights disposed on each side of the rear portion.

The pair of taillights 16L,R can be configured to illuminate areas forward and to the sides of the vehicle 10 with taillight projections 36L,R extending therefrom. The taillight projections 36L,R can be configured to illuminate and make visible the rear portion of the vehicle 10, as well as to illuminate surfaces near the vehicle 10, even projecting generally outward to illuminate other objects. Intensity of the taillight projections 36L,R can be adjusted so as to provide adequate illumination of the rear portion of the vehicle 10, and to observe ground surfaces and/or other objects without visually impairing other vehicle operators or pedestrians.

The pair of fog lights 18L,R shown in FIG. 1 can be included in a front portion of the body 12 and may specifically be disposed within or above the front bumper, and may be positioned above, below or alongside the respective headlights 14L,R. The fog lights 18L,R can be oriented to face approximately forward while also being at least partially angled towards respective sides of the vehicle 10. The fog lights 18L,R can be configured to project illumination beams below those of the headlights 14L,R so as to avoid illuminating fog and mist formed above ground surfaces. The fog lights 18L,R may include halogen, high intensity discharge (HID), light-emitting diode (LED), or laser light sources. Each of the pair of fog lights 18L,R may include any number of appropriate light sources, such as one, two, three, four, etc. Arrangements and orientations of light sources within the fog lights 18L,R can vary depending on application to accommodate various function and design goals. Furthermore, the fog lights 18L,R may comprise multiple fog light units such that the vehicle 10 has one, two, three, four, etc. fog lights disposed on each side of the front portion.

The pair of fog lights 18L,R can be configured to illuminate areas forward and to the sides of the vehicle 10 with fog light projections 38L,R extending therefrom. The fog light projections 38L,R can be configured to cover ground areas to illuminate surfaces near the vehicle 10, as well as projecting generally outward to illuminate other objects. The fog lights 18L,R may further be configured as adaptive fog lights capable of swiveling and moving light sources within respective fog light housings to alter illumination direction and targets of the fog light projections 38L,R. Intensity of the fog light projections 38L,R can also be adjusted so as to provide adequate illumination to observe ground surfaces and/or other objects without visually impairing other vehicle operators or pedestrians.

Some embodiments of the vehicle 10 may include rear fog lights disposed proximate the taillights 16L,R at the rear portion. In such embodiments, the rear fog lights may function similarly to the fog lights 18L,R included in the front portion of the vehicle 10 as described above. Rear fog lights may also be configured to provide enhanced illumination of the rear portion of the vehicle 10, and may further assist in distinguishing approximate orientation of the vehicle 10 on a roadway, such as by indicating a left or right side of the body 12.

The pair of mirror lights 20L,R shown in FIG. 1 can be included in respective side mirrors proximate A-pillars of the body 12 and may specifically be disposed along an underside or side portion of the side mirrors. The mirror lights 20L,R can be oriented to face approximately downward while also being at least partially angled outward from respective sides of the vehicle 10. The mirror lights 20L,R can be configured as welcome lights or puddle lights so as to illuminate ground surfaces proximate the doors to assist entry and exit of passengers into and out of the vehicle 10. The mirror lights 20L,R may additionally include turn signals, or turn signals may alternatively be form as separate light sources within the respective side mirrors. The mirror lights 20L,R may include halogen, high intensity discharge (HID), light-emitting diode (LED), or laser light sources. Each of the pair of mirror lights 20L,R may include any number of appropriate light sources, such as one, two, three, four, etc. Arrangements and orientations of light sources within the mirror lights 20L,R can vary depending on application to accommodate various function and design goals. Furthermore, the mirror lights 20L,R may comprise multiple mirror light units such that the vehicle 10 has one, two, three, four, etc. mirror lights disposed on each side of the vehicle 10 proximate the respective A-pillars.

The pair of mirror lights 20L,R can be configured to illuminate areas to the sides of the vehicle 10 with mirror light projections 40L,R extending therefrom. The mirror light projections 40L,R can be configured to cover ground areas to illuminate surfaces near the vehicle 10, as well as projecting generally outward to illuminate other objects. The mirror lights 20L,R may further be configured as adaptive mirror lights capable of swiveling and moving light sources within respective side mirrors to alter illumination direction and targets of the mirror light projections 40L,R. Intensity of the mirror light projections 40L,R can also be adjusted so as to provide adequate illumination to observe ground surfaces and/or other objects without visually impairing other vehicle operators or pedestrians. The mirror light projections 40L,R can also be configured as designs including various colors and text such as to display an image and/or a message on ground surfaces proximate the mirror lights 20L,R. For example, the mirror light projections 40L,R can include logos, symbols, phrases, instructions, etc.

The pair of door handle lights 22L,R shown in FIG. 1 can be included in respective door handles of respective doors and may specifically be disposed along an underside or inner portion of the door handles. The door handle lights 22L,R can be oriented to face approximately downward while also being at least partially angled outward from respective sides of the vehicle 10. The door handle lights 22L,R can be configured as welcome lights or puddle lights so as to illuminate ground surfaces proximate the doors to assist entry and exit of passengers into and out of the vehicle 10, as well as to illuminate the door handle to facilitate identification thereof to pedestrians and potential operators. The door handle lights 22L,R may include halogen, high intensity discharge (HID), light-emitting diode (LED), or laser light sources. Each of the pair of door handle lights 22L,R may include any number of appropriate light sources, such as one, two, three, four, etc. Arrangements and orientations of light sources within the door handle lights 22L,R can vary depending on application to accommodate various function and design goals. Furthermore, the door handle lights 22L,R may comprise multiple door handle light units such that the vehicle 10 has one, two, three, four, etc. door handle lights disposed in each door handle of the vehicle 10 on respective doors. The exemplary vehicle 10 may have one, two three, four, etc. doors to which door handles are attached, each door handle being configured to include door handle lights therein such that the vehicle 10 may include one, two, three, four etc. door handle lights.

The pair of door handle lights 22L,R can be configured to illuminate areas to the sides of the vehicle 10 with door handle light projections 42L,R extending therefrom. The door handle light projections 42L,R can be configured to cover ground areas to illuminate surfaces near the vehicle 10, as well as projecting generally outward to illuminate other objects. The door handle lights 22L,R may further be configured as adaptive door handle lights capable of swiveling and moving light sources within respective door handles to alter illumination direction and targets of the door handle light projections 42L,R. Intensity of the door handle light projections 42L,R can also be adjusted so as to provide adequate illumination to observe ground surfaces and/or other objects without visually impairing other vehicle operators or pedestrians. The door handle light projections 42L,R can also be configured as designs including various colors and text such as to display an image and/or a message on ground surfaces proximate the door handle lights 22L,R. For example, the handle light projections 42L,R can include logos, symbols, phrases, instructions, etc.

The pair of underbody lights 24L,R shown in FIG. 1 can be included in underbody sills of respective sides of the vehicle 10 and may specifically be disposed beneath the doors. The underbody lights 24L,R can be oriented to face approximately downward while also being at least partially angled outward from respective sides of the vehicle 10. The underbody lights 24L,R can be configured as welcome lights or puddle lights so as to illuminate ground surfaces beneath and around the doors to assist entry and exit of passengers into and out of the vehicle 10. The underbody lights 24L,R may include halogen, high intensity discharge (HID), light-emitting diode (LED), or laser light sources. Each of the pair of underbody lights 24L,R may include any number of appropriate light sources, such as one, two, three, four, etc. Arrangements and orientations of light sources within the underbody lights 24L,R can vary depending on application to accommodate various function and design goals. Furthermore, the underbody lights 24L,R may comprise multiple underbody light units such that the vehicle 10 has one, two, three, four, etc. underbody lights disposed within the sills beneath each door of the vehicle 10. The exemplary vehicle 10 may have one, two three, four, etc. doors beneath which underbody lights are disposed, underbody sills proximate each door being configured to have underbody lights therein such that the vehicle 10 may include one, two, three, four etc. underbody lights.

The pair of underbody lights 24L,R can be configured to illuminate areas to the sides of the vehicle 10 with underbody light projections 44L,R extending therefrom. The underbody light projections 44L,R can be configured to cover ground areas to illuminate surfaces near the vehicle 10, as well as projecting generally outward to illuminate other objects. The underbody lights 24L,R may further be configured as adaptive underbody lights capable of swiveling and moving light sources within respective underbody sills to alter illumination direction and targets of the underbody light projections 44L,R. Intensity of the underbody light projections 44L,R can also be adjusted so as to provide adequate illumination to observe ground surfaces and/or other objects without visually impairing other vehicle operators or pedestrians. The underbody light projections 44L,R can also be configured as designs including various colors and text such as to display an image and/or a message on ground surfaces proximate the underbody lights 24L,R. For example, the underbody light projections 44L,R can include logos, symbols, phrases, instructions, etc.

The interior lighting system 26 of the present embodiment can be configured to include front reading lights, rear reading lights, door panel lights, interior door sill lights, footwell lights, pillar lights, dashboard lights, and console lights, for example. The interior lighting system 26 can be arranged to illuminate a variety of surfaces and relative directions within, as well as outside of, the vehicle 10. For instance, some light sources of the interior lighting system 26 can be configured as welcome lights or puddle lights so as to illuminate the vehicle 10 for facilitate identification and locating by passengers and potential operators, in addition to ground surfaces around an exterior of the vehicle 10 to assist entry and exit of passengers into and out of the vehicle 10. The interior lighting system 26 may include halogen, high intensity discharge (HID), light-emitting diode (LED), or laser light sources. Each of the interior lighting system 26 may include any number of appropriate light sources, such as one, two, three, four, etc. Arrangements and orientations of light sources within the interior lighting system 26 can vary depending on application to accommodate various function and design goals. Furthermore, the interior lighting system 26 may comprise multiple interior light units such that the vehicle 10 has one, two, three, four, etc. interior lights disposed within the interior of the vehicle 10.

The interior lighting system 26 can be configured to illuminate areas within and outside of the vehicle 10 with interior lighting system projections extending from individual interior light sources. The interior lighting system projections can be configured to cover interior surfaces as well as outside areas to illuminate the vehicle interior for assisting locating the vehicle 10, as well as projecting generally outward to illuminate other objects and surfaces. The interior lighting system 26 may further be configured with adaptive interior lights capable of swiveling and moving light sources within respective interior light housings to alter illumination direction and targets of the interior lighting system projections. Intensity of the interior lighting system projections can also be adjusted so as to provide adequate illumination to observe interior and ground surfaces and/or other objects without visually impairing other vehicle operators or pedestrians. The interior lighting system projections can also be configured as designs including various colors and text such as to display an image and/or a message on interior and/or ground surfaces proximate the individual interior lights. For example, the interior lighting system projections can include logos, symbols, phrases, instructions, etc.

### II. Lighting System ECU

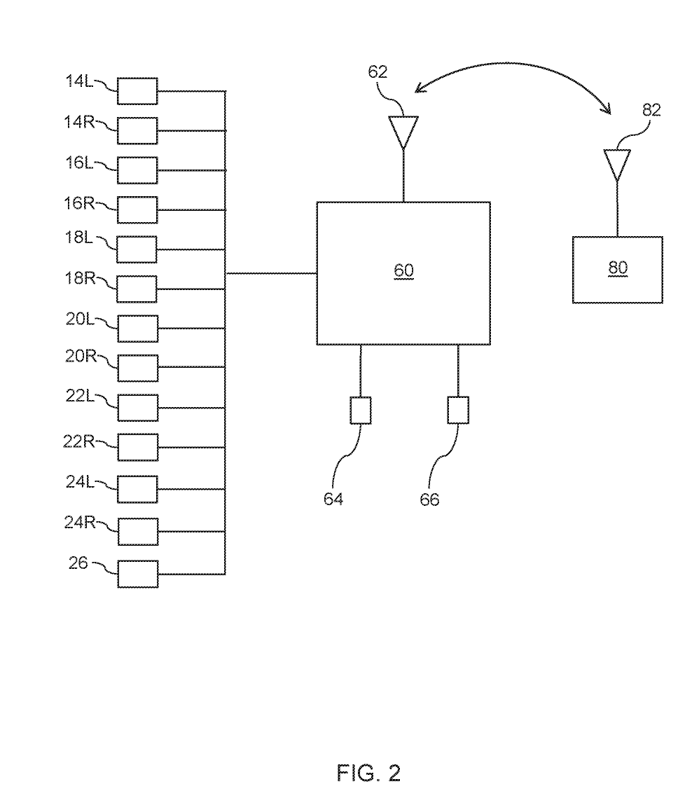

FIG. 2 is a schematic representation of the lighting system 30 in accordance with the disclosed subject matter. The lighting system 30 of the present embodiment can include an ECU 60 configured to be in communication with a key fob 80. Particularly, the ECU 60 can include an ECU transmitter 62 to send and receive signals to and from a key fob transmitter 82 of the key fob 80. Similarly, the key fob transmitter 82 can be configured to send and receive signals to and from the ECU transmitter 62. Signals transmitted between the ECU transmitter 62 and the key fob transmitter 82 may be infrared, radio waves, or any other appropriate medium of signal transmission. Communications for transmission may include locking/unlocking of doors, opening/closing of windows, switching on/off lights (interior and exterior), opening/closing sunroof/moon roof, opening/closing convertible top, opening/closing trunk/tailgate and/or hood, etc. Communications may be transmitted between the ECU 60 and the key fob 80 via buttons disposed thereon, such as lock and unlock buttons on the key fob 80.

In some embodiments, the key fob 80 may be configured as a smart key to communicate with the ECU 60 of the vehicle 10. The key fob 80 configured as a smart key can engage in hands-free operation with the ECU 60, such as in a passive keyless entry/start system. Smart key systems function as proximity systems in which a transducer communicates to the ECU 60 that the key fob 80 is within a certain range of the vehicle 10, thereby granting the ECU 60 permission to accomplish various tasks such as unlocking or starting the vehicle 10. For example, the key fob 80 may be configured to automatically transmit a signal to the ECU 60 once within the prescribed range of the vehicle 10 to unlock the doors, thereby unlocking the doors without actuation of unlock button(s).

The key fob 80 of the present embodiment can be configured as a smart key to communicate both distance from the vehicle 10, specifically the ECU 60, and relative orientation to the vehicle 10. Computing distance and orientation, the key fob 80 can determine where the key fob 80 is in relation to the vehicle 10, and if the key fob 80 is in motion, in what direction the key fob 80 is moving. The ECU 60 can determine proximity and path of movement of the key fob 80, and therefore calculate whether the key fob 80 is moving towards or away from the vehicle 10, and angle of approach/departure. With the aforementioned data, the ECU 60 can anticipate whether the operator/user of the key fob 80 is intending to enter or exit the vehicle 10.

The ECU 60 of the vehicle 10 can also be in communication with the headlights 14L,R, the taillights 16L,R, the fog lights 18L,R, the mirror lights 20L,R, the door handle lights 22L,R, the underbody lights 24L,R, and the interior lighting system 26. The ECU 60 may thereby control operation of the aforementioned lighting components, including switching the components on/off in various combinations, adjusting and setting intensity of the components, and swiveling and moving the components so as to control direction and distance of light projections therefrom. Thus, the ECU 60 can select which lighting components are switched on, the direction(s) which those components are directed, and intensity of light projected therefrom. The ECU 60 is therefore capable of illuminating certain areas of and around the vehicle 10 including interior and exterior surfaces of the vehicle 10, as well as ground surfaces around the vehicle 10 and other objects.

As described above, the key fob 80 of the present embodiment can transmit to the ECU 60 location and direction of approach/retreat relative to the vehicle 10. Using that information, the ECU 60 can then selectively operate any combination of the aforementioned lighting components to provide illuminated areas of the vehicle 10 nearby ground surfaces to facilitate entry to or exit from the vehicle 10. Since each of the aforementioned lighting components of the vehicle 10 are individually controllable, the ECU 60 can elect to switch on only those components proximate and directed towards the key fob 80 during approach or departure relative to the vehicle 10. Furthermore, the ECU 60 can be configured to continuously monitor position of the key fob 80 and may thus continuously alter which lighting components are switched on, and swivel or move those lighting components in response to movement of the key fob 80. As the key fob 80 moves, intensity of the lighting components can also be continuously adjusted. In instances in which the key fob 80 moves around different portions of the vehicle 10, the ECU 60 can switch off lighting components no longer proximate the moving key fob 80 while switching on components that become proximate thereto.

For example, when the key fob 80 approaches the vehicle 10 from a left side, each of the following lighting components may be switched on: the headlight 14L, the taillight 16L, the fog light 18L, the mirror light 20L, the door handle light 22L, the underbody light 24L, and the interior lighting system 26, or any combination thereof. Furthermore, those of the aforementioned components configured to swivel or move may additionally be directed towards the key fob 80, and intensity of the components may adjust accordingly to provide appropriate illumination while avoiding harm to an operator/user of the key fob 80 or other pedestrians and/or vehicle operators. The illuminated path to or from the vehicle 10 described above can be continuously altered to adapt to and account for changes in both distance and direction of approach/departure of the key fob 80 relative to the vehicle 10. In the present embodiment in which the key fob 80 is a smart key and automatically transmits positional information to the ECU 60, the lighting system 30 can thus be configured to automatically provide an illuminated path to and from the vehicle 10 for the operator/user of the key fob 80. The operator/user consequently does not need to actuate any buttons of the key fob 80 to have the appropriate path illuminated.

As described below, the key fob 80 may alternatively be configured as a cellphone, particularly a smartphone such that a cellphone operated by a user may perform smartphone functions while being able to communicate with the ECU 60 of the vehicle 10 to illuminate a path to the vehicle 10.

### III. Vehicle Sensors

The ECU 60 of the present embodiment of the vehicle 10 may be configured to be connected to a light sensor 64 and a condition sensor 66. The light sensor 64 and the condition sensor 66 may therefore be configured to communicate data to the ECU 60 based on exterior conditions to the vehicle 10 so that the ECU 60 can determine whether to process certain functions.

The light sensor 64 in communication with the ECU 60 can be configured to measure and transmit an amount of ambient light outside of the vehicle 10. The amount of ambient light may be affected by time of day, sunlight intensity, artificial light intensity such as that provided by indoor lighting sources (i.e., in a tunnel, parking garage). The ECU 60 thus receives data regarding the amount of ambient light from the light sensor 64 and can determine whether that amount exceeds a threshold amount of light. If the threshold amount of light is exceeded, the ECU 60 may then be configured to automatically provide an illuminated path to and from the vehicle 10 for the operator/user of the key fob 80, as described above. However, if the threshold amount of light is not exceeded, the ECU 60 may alternatively not provide the illuminated path to and from the vehicle 10 since sufficient ambient light is present for the operator/user of the key fob 80 to approach or retreat from the vehicle 10.

The condition sensor 66 in communication with the ECU 60 can be configured to measure and transmit conditions, such as precipitation (i.e., rain, snow, hail, ice) and ground surface debris (i.e., water, snow, ice, gravel, dirt, mud), outside of the vehicle 10. The presence, amount, and degree of precipitation and/or ground surface debris may be affected by a variety of factors such as weather or surface composition. The ECU 60 thus receives data regarding the exterior conditions from the condition sensor 66 and can determine whether that presence, amount, and/or degree of a particular condition exceeds a threshold. If the threshold for the particular condition is exceeded, the ECU 60 may then be configured to automatically provide an illuminated path to and from the vehicle 10 for the operator/user of the key fob 80, as described above. However, if the threshold condition is not exceeded, the ECU 60 may alternatively not provide the illuminated path to and from the vehicle 10 since absence particular conditions does not impede the operator/user of the key fob 80 from approaching or retreating from the vehicle 10.

### IV. Alternative Embodiments

While certain embodiments of the invention are described above, and FIGS. 1-2 disclose the best mode for practicing the various inventive aspects, it should be understood that the invention can be embodied and configured in many different ways without departing from the spirit and scope of the invention.

For example, embodiments are disclosed above in the context of the exemplary lighting system 30 of the vehicle 10 as shown in FIGS. 1-2. However, embodiments are intended to include or otherwise cover a lighting system configured for illuminating interior and exterior surfaces of a vehicle, as well as nearby ground surfaces and objects, as disclosed above.

In fact, in some embodiments, the lighting system 30 of the exemplary vehicle 10 can include the ECU 60 configured to communicate with a transducer within the key fob 80. Furthermore, the key fob 80 may be configured to communicate with the ECU 60 via alternative means such as Bluetooth or over wireless internet connection (wifi). The key fob 80 may further be configured to communicate with the ECU 60 over a dedicated wifi network within the vehicle 10 in accordance with the disclosed subject matter. Additionally, the key fob 80 may alternatively be configured as or included within another device such as a cellphone, specifically a smartphone, a watch, a pair of glasses, a wallet, etc.

In some embodiments, a communication device can be used to perform the operations of the key fob 80 discussed above. The communication device can be configured to send and receive signals, specifically with at least the ECU 60. The communication device can be separate from, or a part of, the key fob 80. As described above, the communication device configured to perform the operations of the key fob 80 may be configured as a cellphone, particularly a smartphone.

All or some of the alternative structures disclosed above with regard to the lighting system 30 also apply to non-vehicular applications. The above alternative configurations of the lighting system 30 are merely provided for exemplary purposes, and as indicated above, embodiments are intended to cover any type of lighting system 30 configured to selectively switch on/off and direct light sources to illuminate a pathway corresponding to a remote transmitting device that operate or otherwise perform as disclosed above.

As disclosed above, embodiments are intended to be used with any type of vehicle. The power source of the vehicle can be an internal combustion engine, an electric motor, or a hybrid of an internal combustion engine and an electric motor. The power source configured as an internal combustion engine or a hybrid power source can have the engine output axis oriented in the longitudinal direction or in the traverse direction of the vehicle. The engine can be mounted forward of the front axles, rearward of the rear axles, or intermediate the front and rear axles.

The vehicle can include any type of transmission, including an automatic transmission, a manual transmission, or a semi-automatic transmission. The transmission can include an input shaft, an output shaft, and a speed ratio assembly.

Embodiments are also intended to include or otherwise cover methods of using and methods of manufacturing any or all of the elements disclosed above. The methods of manufacturing include or otherwise cover processors and computer programs implemented by processors used to design various elements of the lighting system disclosed above.

While the subject matter has been described in detail with reference to exemplary embodiments thereof, it will be apparent to one skilled in the art that various changes can be made, and equivalents employed, without departing from the scope of the invention. All related art references discussed in the above Background section are hereby incorporated by reference in their entirety.

1. A vehicle lighting system for use with a fob, the fob being configured to transmit a signal including a position of the fob relative to the vehicle, the vehicle including at least one area of passenger ingress/egress, the vehicle lighting system comprising:
a plurality of light sources disposed in different housings on the vehicle; and
a processor configured to:
receive the signal from the fob;
determine a path of travel of the fob to the at least one area of passenger ingress/egress;
select multiple of the plurality of light sources in different housings that are capable of illuminating the path of travel; and
activate the selected plurality of light sources to illuminate the path of travel.

2. The vehicle lighting system according to claim 1, further comprising a first sensor configured to measure presence of a condition and transmit the measurement to the processor such that the processor is configured to determine whether the condition is present, the processor configured to activate the selected plurality of light sources in the presence of the condition.

3. The vehicle lighting system according to claim 2, wherein the first sensor is configured to measure presence of at least one of rain, snow, hail, ice.

4. The vehicle lighting system according to claim 3, wherein the first sensor is configured to measure surface composition of that which the vehicle is disposed on.

5. The vehicle lighting system according to claim 2, further comprising a second sensor configured to measure an amount of light and transmit the measurement to the processor such that the processor is configured to determine whether the amount of light exceeds a threshold, the processor configured to activate the selected plurality of light sources in the presence of the amount of light exceeding the threshold.

6. The vehicle lighting system according to claim 5, wherein the second sensor is configured to measure ambient light outside the vehicle.

7. The vehicle lighting system according to claim 1, wherein the processor is configured to adjust an intensity of the selected plurality of light sources.

8. The vehicle lighting system according to claim 7, wherein the processor is configured to adjust a pattern of the selected plurality of light sources.

9. The vehicle lighting system according to claim 1, wherein the selected plurality of light sources is configured to be motorized so as to be moveable, and the processor is configured to control movement of the selected plurality of light sources to illuminate the path of travel.

10. The vehicle lighting system according to claim 1, wherein the fob is configured as a smartphone to perform additional functions including calling and data transfer.

11. A vehicle for use with a fob, the fob being configured to transmit a signal including a position of the fob relative to the vehicle, the vehicle comprising:
at least one area of passenger ingress/egress; and
a lighting system disposed at different locations on the vehicle, the lighting system including:
a plurality of light sources disposed in different housings on the vehicle; and
a processor configured to:
receive the signal from the fob;
determine a path of travel of the fob to the at least one area of passenger ingress/egress;
select multiple of the plurality of light sources in different housings that are capable of illuminating the path of travel; and
activate the selected plurality of light sources to illuminate the path of travel.

12. The vehicle according to claim 11, wherein the lighting system further comprises a first sensor configured to measure presence of a condition and transmit the measurement to the processor such that the processor is configured to determine whether the condition is present, the processor configured to activate the selected plurality of light sources in the presence of the condition.

13. The vehicle according to claim 12, wherein the first sensor is configured to measure presence of at least one of rain, snow, hail, ice.

14. The vehicle according to claim 13, wherein the first sensor is configured to measure surface composition of that which the vehicle is disposed on.

15. The vehicle according to claim 12, wherein the lighting system further comprises a second sensor configured to measure an amount of light and transmit the measurement to the processor such that the processor is configured to determine whether the amount of light exceeds a threshold, the processor configured to activate the selected plurality of light sources in the presence of the amount of light exceeding the threshold.

16. The vehicle according to claim 15, wherein the second sensor is configured to measure ambient light outside the vehicle.

17. The vehicle according to claim 11, wherein the processor is configured to adjust at least one of an intensity and a pattern of the selected plurality of light sources.

18. The vehicle according to claim 11, wherein the selected plurality of light sources is configured to be motorized so as to be moveable, and the processor is configured to control movement of the selected plurality of light sources to illuminate the path of travel.

19. The vehicle according to claim 11, wherein the fob is configured as a smartphone to perform additional functions including calling and data transfer.

20. A method of illuminating a vehicle lighting system of a vehicle for use with a fob, the fob being configured to transmit a signal including a position of the fob relative to the vehicle, the vehicle including at least one area of passenger ingress/egress, the vehicle lighting system including a plurality of light sources disposed in different housings on the vehicle, and a processor, the method comprising:
receiving the signal from the fob to the processor;
determining a path of travel of the fob to the at least one area of passenger ingress/egress via the processor;
selecting multiple of the plurality of light sources in different housings that are capable of illuminating the path of travel via the processor; and
activating the selected plurality of light sources to illuminate the path of travel via the processor.
